(19) United States
(12) Patent Application Publication
(10) Pub. No.: US 2002/0185576 A1
(43) Pub. Date: Dec. 12, 2002

(54) Removable wire caddy for electrician's ladder

(76) Inventor: Terry K. Harper, Carrollton, GA (US)

Correspondence Address: George M. Thomas, THOMAS, KAYDEN,, HORSTEMEYER & RISLEY, L.L.P., 100 Galleria Parkway, N.W., Suite 1750, Atlanta, GA, 30339-5948, US

(21) Appl. No.: 09/876,688

(22) Filed: Jun. 7, 2001

(51) Int. Cl. E06C 7/14; A47K 1/00; E04G 3/00

(52) U.S. Cl. 248/210; 248/214

(57) ABSTRACT

A removable wire caddy 10 that is constructed for use on a step ladder 12, or which may be used independently of a ladder, to hold and dispense spools of wire 7. The wire caddy comprises a support bar 23 intermediately connected to a pair of spacer bars 25, 26, the spacer bars 25, 26 being intermediately connected to a base leg 24 of a U-shaped frame 14. A pair of parallel side legs 16, 17 extend from the opposing ends of the base leg 24 of the U-shaped frame 14, and a rectilinear spool support rod 18 is releasably supported between said parallel side legs 16, 17. The configuration of the spacer bars 25, 26, support bar 23 and base leg 24 form two c-shaped recesses 27, 28 that straddle the side rails 29, 30 of the ladder 12. The spacer bars 25, 26 rest on the step 31 of a ladder 12, the support bar 23 engages behind the side rails 29, 30 of the ladder 12 and the U-shaped frame 14 supports the spools of wire 7 out in front of the ladder 12.

### TECHNICAL FIELD

The present invention is generally related to a wire caddy, for holding and dispensing different spools of wire, which is attachable to a ladder. More particularly, the present invention relates to a wire caddy that is attachable to a ladder and capable of holding spools of wire typically used by electricians.

### BACKGROUND OF THE INVENTION

In the electrical trade, it is common for electricians to use large quantities of various types of electrical wire. Typically, each type of electrical wire is wound around a separate spool. If an electrician is performing work that requires the simultaneous use of several types of wire, he must carry numerous spools of wire from location to location.

Electricians often perform work in elevated areas and must use ladders to reach these high spaces. When the electrician is on a ladder performing work that requires different types of wire, he must either leave the spools of wire on the floor or carry multiple spools up the ladder as he works. It is difficult for an electrician to pull wires from spools resting on the floor while working on a ladder. Frequently, the electrician will have to climb up and down the ladder to retrieve wire ends or untangle wires. If the electrician attempts to carry multiple spools of wire up the ladder, it is difficult to balance on the ladder, maintain control over the various spools of wire and complete the electrical work.

In the past, various systems and methods for holding and dispensing wire from spools have been developed. For instance, mobile floor racks have been devised to accommodate multiple spools of wire. When the electrician is not working on a ladder, the mobile floor racks adequately hold and dispense spools of wire. However, when the electrician is working on a ladder, each time a change in position is desired, both the ladder and the mobile floor rack must be adjusted. Furthermore, because the electrician must still reach down from the ladder to a mobile floor rack to retrieve a desired wire, such racks do not preclude dangerous leaning or prevent potential falls from the ladder. Mobile floor racks are often cumbersome and are, therefore, not easily moved from site to site by the electrician.

To accommodate working on ladders and handling multiple spools of wire, previous inventions have attached a shaft across the side rails of a standard ladder by cutting notches into the side rails of the ladder across which the shaft is positioned. The spools of wire are then slipped onto the shaft and the wire can be unwound directly from a position on the ladder or ground. Although such a configuration alleviates the need for an electrician to repeatedly get off the ladder or move a floor rack, the shaft may fall out or be pulled out of the notches by the electrician's movements or placement of the ladder, thus spilling the spools of wire. Furthermore, such a configuration may pose a safety risk because the notches cut into the rails may weaken the structure of the ladder and cause it to fail.

In U.S. Pat. No. 4,533,091 to Knight et al, the spools of wire are mounted on a shaft that is attached by brackets placed on the rails of a ladder to form a wire dispensing device. The Knight device is limited in that it may only be used to hold and dispense spools of wire when the ends of its shaft are maintained into a locked position by the brackets mounted on the ladder. If the ends of its shaft are not locked into the brackets, the movement of the electrician pulling on the wires can cause the spools to slide off of the shaft. Additionally, the Knight dispensing device is limited in that it cannot be readily moved from site to site and used without also moving the ladder and/or brackets.

In U.S. Pat. No. 4,869,344 to Peterson, a wire storage and dispensing device is shown which contains elements of a mobile floor rack and a device that attaches to the rails of a ladder. The Peterson device is positioned on the floor and attached to the rails of a ladder for stability. As with other prior art, the Peterson device is cumbersome and difficult to move from site to site without also moving the ladder and/or attaching brackets.

Thus, a heretofore unaddressed need exists in the industry to address the aforementioned deficiencies and inadequacies.

### SUMMARY OF THE INVENTION

The present invention provides a device and method for storing and dispensing wire from spools. More particularly, the present invention is a wire caddy configured to store and dispense spools of wire as an independent and easily moveable unit or as a removable attachment to a standard step ladder.

Briefly described, in architecture, one embodiment of the system, among others, can be implemented as follows. The present invention is a device for supporting work implements having a step engaging mechanism, a side rail engaging mechanism and a support structure. The present invention is removably attachable to a ladder by the step engaging mechanism, which extends across and rests upon a step of the ladder, and by the side rail engaging mechanism, which rests against the rear surface of the side rails above the engaged step of the ladder. The support structure of the present invention is attached to the step engaging mechanism and comprises a U-shaped frame having parallel spaced side legs and a base leg extending between said side legs. A spool support rod is releasably mounted, such as with cotter pins, through openings in the side legs of the support structure, thereby permitting spools of wire to be rotatably mounted to the support rod. Furthermore, the configuration of the step engaging mechanism to the side rail engaging mechanism provides a multitude of handles by which the wire caddy may be manipulated or carried. Thus, the present invention provides a support structure for storing and dispensing multiple spools of wire that may either be removably attached to a step of a ladder or used independently.

In a preferred embodiment, the support structure is rigidly constructed from a material suitable in strength to support multiple spools of wire while in a suspended position across the step of a ladder. The support structure is configured so that the spool support rod is oriented horizontally and so that the spools of wire are projected outwardly from the ladder. However, the length of the parallel spaced side legs of the U-shaped frame is not so great so as to impede a person from climbing up or down the steps of the ladder when the spool support rod is loaded with spools of wire. The weight of the fully-loaded spool support rod is partially counter-balanced by the weight and positioning of the side rail engaging mechanism and by the ladder itself, assuring that the ladder will not overturn when the present invention is attached.

The present invention can also be viewed as providing methods for storing and dispensing spools of wire. In this regard, one embodiment of such a method, among others, can be broadly summarized by the following steps: mounting spools of wire onto a spool support rod of a wire caddy; suspending the spool support rod between the adjacent distal ends of parallel side legs extending from the end portions of a base leg of the wire caddy; securing the spool support rod to the distal ends of the parallel side legs; and, optionally, attaching the wire caddy to a ladder. The wire caddy is attached to the ladder by engaging a step and side rails of the ladder with the configuration of a support bar oriented in parallel to a base leg and connected thereto with a pair of spacer bars forming an opening which registers around the side rails of the ladder. The spools of wire are then mounted onto the spool support rod by removing one end of the rod from between the parallel side legs and then threading the wire spool onto the spool support rod. The end of the rod is then secured in position by suitable fastening means, such as a cotter pin or other type of locking pin.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the wire caddy mounted on a step ladder, illustrating the placement and attachment of the wire caddy onto the ladder for use in storing and dispensing spools of wire.

FIG. 2 is a frontal view illustrating the use of the wire caddy as an independent and easily moveable unit.

FIG. 3 is a side elevational view illustrating the position of the wire caddy mounted across a step of the ladder.

### DETAILED DESCRIPTION OF THE PREFERRED EMBODIMENT

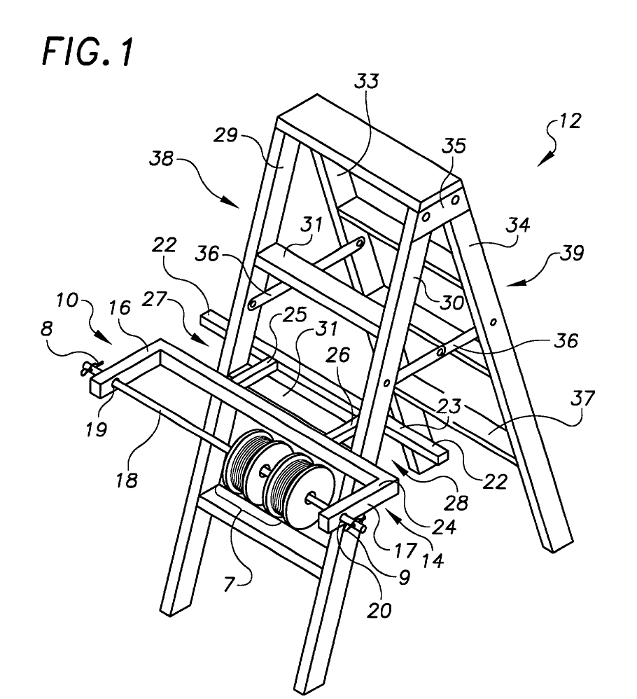

As illustrated in FIGS. 1-3, there is shown a wire caddy 10 configured for attachment to a step ladder 12 or for independent use. FIGS. 1 and 3 illustrate the attachment of the wire caddy 10 to a ladder 12. The ladder 12 is a standard type step ladder as generally known in the art. The ladder 12 is configured with two portions, a step portion 38 having side rails 29, 30 connected by steps 31, and a rear portion 39 having side rails 33, 34 connected by steps 31 or rungs 37. The step portion 38 and rear portion 39 of the ladder 12 are typically connected in a known manner with pivot joints 35 at the top of the ladder 12 and at least one locking hinge 36, interposed between the side rails 29, 30 of the step portion 38 and the side rails 33, 34 of the rear portion 39 to lock the ladder 12 in an open position.

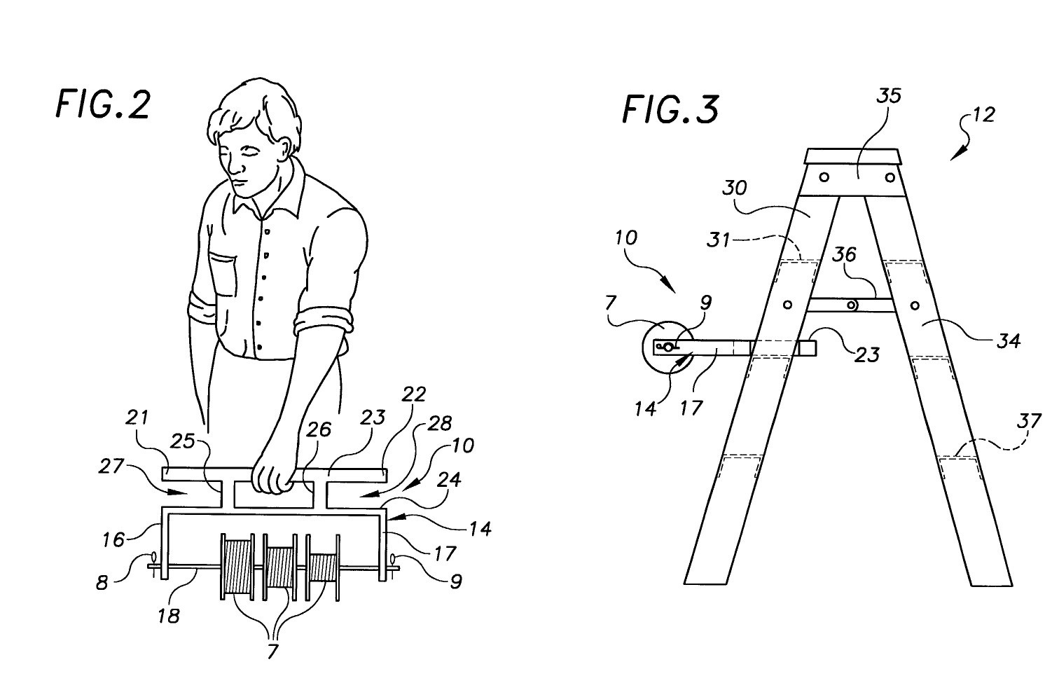

As shown in FIGS. 1 and 2, the wire caddy 10 includes a U-shaped frame 14 having opposed parallel legs 16, 17, a base leg 24 and a spool support rod 18 interposed through openings 19, 20 in the distal ends of the parallel legs 16, 17. A support bar 23 of the frame 14 is oriented parallel to the base leg 24 of the U-shaped frame 14 and is connected thereto with parallel spacer bars 25, 26. The spool support rod 18 is secured into position between the parallel legs 16, 17 by a suitable fastening means, such as the cotter pins 8, 9. In this manner, the spool support rod 18 is secured in position and inadvertent detachment from the frame 14 during use is avoided. The spools of wire 7 are rotatably mounted about the spool support rod 18 by first removing one of the cotter pins 8, 9 and sliding the spool support rod 18 through one of the openings 19, 20. The spools of wire 7 may then be threaded onto the spool support rod 18, whereafter the loaded spool support rod 18 is secured back into position. The spools of wire 7 will then freely rotate about the spool support rod 18 during use.

FIG. 1 provides a perspective illustration of the wire caddy 10 mounted on the ladder 12. The spacer bars 25, 26 are positioned intermediately from the distal ends 21, 22 of the support bar 23 and base leg 24 so as to define oppositely facing c-shaped recesses 27, 28. These recesses 27, 28 register about the side rails 29, 30 of the ladder 12 when the wire caddy 10 is mounted to the ladder 12.

As shown in FIGS. 1 and 3, the spacer bars 25, 26 further comprise the step engaging means whereby the spacer bars 25, 26 rest upon a step 31 of the ladder 12 and position the wire caddy 10 so that the spool support rod 18 is oriented horizontally, parallel to the step 31 of the ladder 12, and holds the spools of wire 7 projected outwardly from the ladder 12. The support bar 23 comprises the side rail engaging means and the distal ends 21, 22 of the support bar 23 rest against the rear surface of the side rails 29, 30 above the step 31 of the ladder 12 on which the spacer bars 25, 26 are engaged. The weight of the fully-loaded wire caddy 10 is partially counterbalanced by the support bar 23 and by the weight of the rear portion 39 of the ladder 12, assuring that the ladder 12 will not overturn.

Although the wire caddy 10 is illustrated as being mounted to a conventional step ladder 12 with both a step portion 38 and a rear portion 39, the wire caddy 10 may be mounted to a ladder 12 having only a step portion 38, such as an extension ladder.

FIG. 2 is a front view illustrating the ease with which the wire caddy 10 may be used independently to transport, store and dispense electrical wire from spools of wire 7. The configuration of the parallel spacer bars 25, 26 and the support bar 23 to the frame 14 provides a multitude of handles by which the wire caddy 10 may be manipulated or carried.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A support attachment for mounting work implements on a ladder, the ladder including a pair of upwardly extending substantially parallel side rails spaced from each other and steps extending horizontally between said side rails to enable a person to climb the ladder, said side rails having opposed front and rear surfaces, said support attachment comprising:
a step engaging means for extending across and resting on a step of a ladder;
a side rail engaging means extending from said step engaging means for engaging the rear surface of the side rails of a ladder above the step engaged by said step engaging means; and
a support structure for supporting work implements, said support structure extending from said step engaging means for supporting said support structure at the front surfaces of said side rails of the ladder.

2. The support attachment for a ladder as described in claim 1, wherein:
said support structure for supporting work implements comprises a U-shaped frame including parallel spaced side legs and a base leg extending between said side legs, said base leg joined to said step engaging means, and
a rectilinear spool support rod having opposed ends is releasably mounted to said side legs of said U-shaped frame;
whereby spools of wire can be rotatably mounted on said spool support rod at the front of the side rails of a ladder.

3. The support attachment of claim 2, wherein said U-shaped frame, said step engaging means and said side rail engaging means are of rigid, one piece construction.

4. The support attachment of claim 1, wherein:
said side rail engaging means comprises a rectilinear bar having opposed ends;
said step engaging means comprises a pair of substantially parallel bars extending from said rectilinear bar to said support structure, and
said support structure comprises a U-shaped frame having a base leg with opposed end portions, a pair of parallel side legs extending from the end portions of said base leg, and said base leg connected intermediate its end portions to said parallel bars of said step engaging means; and
a rectilinear spool support rod having opposed ends supported by said parallel side legs of said support structure.

5. The support attachment of claim 4, wherein step engaging means, said side rail engaging means and said support structure occupy a common plane.

6. The support structure of claim 4, wherein said step engaging means, said side rail engaging means, and said support structure are of rigid construction.

7. The support structure of claim 1, wherein said step engaging means, said side rail engaging means and said support structure define oppositely facing c-shaped recesses which register about the side rails of a step ladder.

8. The support structure of claim 1, wherein said step engaging means comprises a pair of substantially parallel spaced apart bars extending from said side rail engaging means for resting at spaced intervals on a step of a step ladder.

9. A method for storing and dispensing spools of electrical wire on a wire caddy, wherein said wire caddy is comprised of a support bar connected to a pair of parallel spacer bars, said spacer bars further connected to a base leg having two parallel legs configured at distal ends thereof and a spool support rod positioned between said parallel legs, comprising the steps of:
suspending said spool support rod between said distal ends of said parallel legs;
securing said spool support rod to said distal end of each of said parallel legs with a suitable fastening means; and
mounting spools of wire onto said spool support rod.

10. The method of claim 9, further comprising the steps of:
positioning said wire caddy on a ladder wherein said spacer bars rest upon a step of said ladder; and
orienting said spool support rod horizontally such that said spools of wire project outwardly from said ladder.

11. The method of claim 10, further comprising the step of configuring said support bar, pair of spacer bars and base leg so as to form oppositely facing c-shaped recesses, each for registering about a side rail of said ladder.

12. The method of claim 9, wherein the spool support rod is suspended between said parallel legs by positioning said spool support rod through openings in said distal ends of said parallel legs.

13. The method of claim 9, wherein said spool support rod is secured to an end of each of said parallel legs by locking pins.

14. The method of claim 9, wherein said spools of wire are mounted onto said spool support rod comprising the steps of:
removing one end of said spool support rod from a secured position at the distal end of a parallel leg by disengaging said fastening means and sliding said spool support rod through an opening in said distal end of said parallel legs;
threading said spooled wire onto said spool support rod; and
securing said spool support rod back into position between said parallel legs.

15. A wire caddy attachable to a ladder, comprising:
a U-shaped frame having a base leg and opposed parallel legs mounted to said base leg;
a spool support rod supported at its ends by said parallel legs;
a support bar; and
a pair of spacer bars interconnecting said U-shaped frame to said support bar.

16. The wire caddy of claim 15, wherein the U-shaped frame is of rigid construction and has sufficient strength to support said wire caddy when fully-loaded with spooled wire.

17. The wire caddy of claim 15, wherein said spool support rod is secured between said parallel legs such that it does not inadvertently detach from said U-shaped frame during use.

18. The wire caddy of claim 17, further comprising spools of wire threaded onto said spool support rod such that said spools of wire are free to rotate about said spool support rod during use.

19. The wire caddy of claim 15, wherein said spacer bars extending from the support bar to said U-shaped frame are sized and spaced from each other to rest upon a step of a ladder.

20. The wire caddy of claim 19, further comprising spacer bars constructed and arranged so that when said spacer bars are placed on a step of a ladder said spool support rod is oriented horizontally and said spooled wire projects outwardly from said ladder.

21. The wire caddy of claim 15, wherein each end of said support bar is constructed and arranged so that the ends of the support bar engage a rear surface of a side rail of a ladder at a position directly above a step engaged by said spacer bars.

22. The wire caddy of claim 15, wherein said spacer bars are intermediately positioned from each distal end of said support bar and said base leg so as to define oppositely facing c-shaped recesses for engagement about the side rails of a ladder.

23. The wire caddy of claim 22, further comprising the positioning of said recesses about each side rail corresponding to a location of said spacer bars across a step of said ladder.
